(19) United States
(12) Patent Application Publication
(10) Pub. No.: US 2006/0190276 A1
(43) Pub. Date: Aug. 24, 2006

(54) System and method for reserving ground transportation

(76) Inventor: Bryan Williamson, Plantation, FL (US)

Correspondence Address: EDWARDS & ANGELL, LLP, P.O. BOX 55874, BOSTON, MA, 02205, US

(21) Appl. No.: 11/061,204

(22) Filed: Feb. 18, 2005

(51) Int. Cl. G06Q 99/00

(52) U.S. Cl. 705/1

(57) ABSTRACT

An inventory of ground transportation vehicles is stored at a server. The inventory includes information about each ground transportation vehicle including fees for travel in a respective ground transportation vehicle as a function of geographical zones to be traveled. A request is made by an end user from a remote computer in communication with the server for ground transportation vehicle. The request includes an origination geographical zone and destination geographical zone. The server compares the request to the inventory and determines those ground transportation vehicles that travel from the origination geographical zone to the destination geographical zone and forwards those ground transportation vehicles and associated fees for traveling between the origination geographical zone and destination geographical zone to the remote computer for display.

### BACKGROUND OF THE INVENTION

This invention is directed to the reservation of shuttle transportation and, more particularly, for reserving, purchasing and pricing shuttle transportation utilizing web-based portals.

Private transportation, such as limousines, sedans, and vans has been known in the art since the beginning of private taxis (collectively, “shuttle transportation”). Generally, a customer contacts the shuttle provider directly by telephone to make a reservation for transportation from one given destination, usually an airport or other point of interest away from the customer's home and car, to another destination such as a hotel or other point of interest. With the advent of the computer, it is known to manually enter and track the reservation on the computer. However, as recognized in the art by Boston Coach by way of example, shuttle reservations are often complex and detailed. Varying routes and times affect not only the availability of shuttles, but the pricing as well. Therefore, human intervention to price and reserve shuttle transportation is often needed.

Some shuttle agencies such as Suvana have determined a method for arranging for shuttle transportation over the Internet through a web portal. However, Suvana overcomes the complexity issue by providing a limited number of destinations such as airports and hotels within driving distance of the airport, using a single shuttle provider. As a result, Suvana is able to predict the cost and availability structure in the closed destination universe it provides. However, although acceptable, it suffers from the shortcomings that it does not allow the customer to reserve transportation to and from any destination they choose, nor does it allow for a variety of vendors. A variety of vendors allows for a competitive bidding and variety of choice to the customer.

Accordingly, a method and system which overcome the shortcomings of the prior art are desired.

### BRIEF SUMMARY OF THE INVENTION

An inventory of ground transportation vehicles is created and stored on a server. The inventory includes fees for traveling in each ground transportation vehicle of the inventory determined as a function of geographical zones to be traveled. A custom request for a ground transportation vehicle is received from a remote computer. The request includes an origination geographical zone and a destination geographical zone. The server compares the request to the inventory of vehicles and determines those ground transportation vehicles that travel from the origination zone to the destination zone and forwards those ground transportation vehicles and associated fees for traveling between the origination zone and destination zone to the remote computer for display.

An end user at the remote computer then selects the desired ground transportation vehicle and forwards the selected vehicle, fee and origination zone and destination zone to the server. The server notifies a vendor of the selected ground transportation vehicle, confirms availability, creates a confirmation number and forwards the confirmation number to the remote computer.

### BRIEF DESCRIPTION OF THE DRAWINGS

For a fuller understanding of the invention, reference is had to the following description taken in connection with the accompanying drawings in which:

FIG. 1 is a schematic drawing of a system for reserving ground transportation constructed in accordance with the invention;

FIG. 2 is a flow diagram for the method of creating the database for reserving ground transportation constructed in accordance with the invention;

FIG. 3 is a screenshot of a table for use in creating the database reserving ground transportation constructed in accordance with the invention;

FIG. 4 is a further screenshot of a table representation of the database for reserving ground transportation constructed in accordance with the invention;

FIG. 5 is a flow diagram of the method for reserving ground transportation in accordance with the invention;

FIG. 6 is a screenshot for reserving ground transportation constructed in accordance with the invention;

FIG. 7 is a screenshot for determining the geographic zone of a destination constructed in accordance with the invention;

FIG. 8 is a screenshot of ground transportation lists for selection constructed in accordance with the invention; and

FIG. 9 is a partial screenshot of the booking fields constructed in accordance with the invention

### DETAILED DESCRIPTION OF THE INVENTION

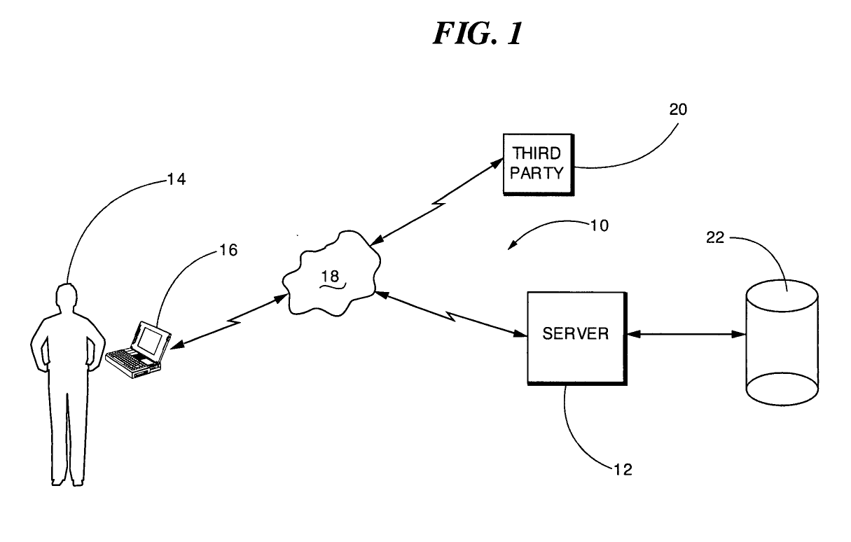

Reference is made to FIG. 1 in which a system, generally indicated as 10 is provided. System 10 includes a server 12 operatively communicating with a database 22. Server 12 communicates with users 14 (“customers”) seeking ground transportation vehicles at a remote computer 16, through Internet 18. Server 12 may also communicate with third party ground transportation vehicle sources though Internet 18. It should be noted that server 12 may communicate with third party sources 20 by telephone and facsimile as will be seen below.

In a preferred embodiment, server 12 provides an interactive web-based portal, such as a web page, for interacting with customer 14. It should be noted that computer 16 may be any interactive device, which allows customer 14 to communicate with server 12 and receive some type of text or audio/visual content at remote computer 16. It should be noted that the preferred embodiment is an Internet-based system with graphical user interface (GUI). However, the system may include any device capable of processing the origination geographical zone, the destination geographical zone and customer information. The computing device/service may communicate with a user 14 by Internet 18 as in the preferred embodiment, by radio frequency, telephone, cable TV, handheld personal data accessory or cellular phone by way of non-limiting examples.

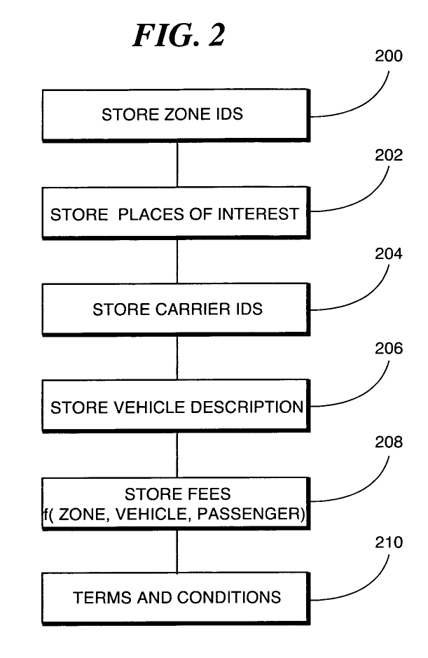

Reference is now made to FIG. 2 in which the steps of the method for creating an inventory of vehicles in database 22 is provided. In a step 200, a geographical area, such as a country, a city, a municipality, or any randomly devised geographical area is divided into geographical zones and assigned an identification number or code. By way of preferred example, zip codes lend themselves almost throughout the world to such geographical zone one-to-one correspondence. However, other self-created codes or other geographical zones, such as voting district precinct numbers, or the like, may be used. The zone identifiers are stored in database 22. It should be noted that in an optional step 202 specific places of interest such as hotels, amusement parks, stadiums, airports or other fixed places of high ground transportation traffic can be assigned their own geographical zone, or may simply utilize the geographical zone in which they reside as determined in step 200.

In a step 204, third party vendor identifiers are stored in server 22. By way of example, the name of a shuttle company may be used or the shuttle company may be assigned a system number to identify it for use within the system. Data files including data associated with a specific carrier as identified by their carrier ID may be stored beginning with a step 206. By way of example, in step 206 each carrier may store a description of its fleet of vehicles which may be used in accordance with the system.

Fees may be stored in accordance with a step 208. Fees are a function of travel distance, type of vehicle and number of passengers. Therefore, a fee schedule for each third party vendor 20 will be determined in the first instance as a function of travel distance which can be determined by determining the distance from geographical zone to geographical zone. In one embodiment, third party vendor 20 determines a price per distance, such as dollars per mile or a fixed base fee plus dollars per mile. Server 12 having zone codes can determine the distance between two zones and calculate an overall cost for the trip.

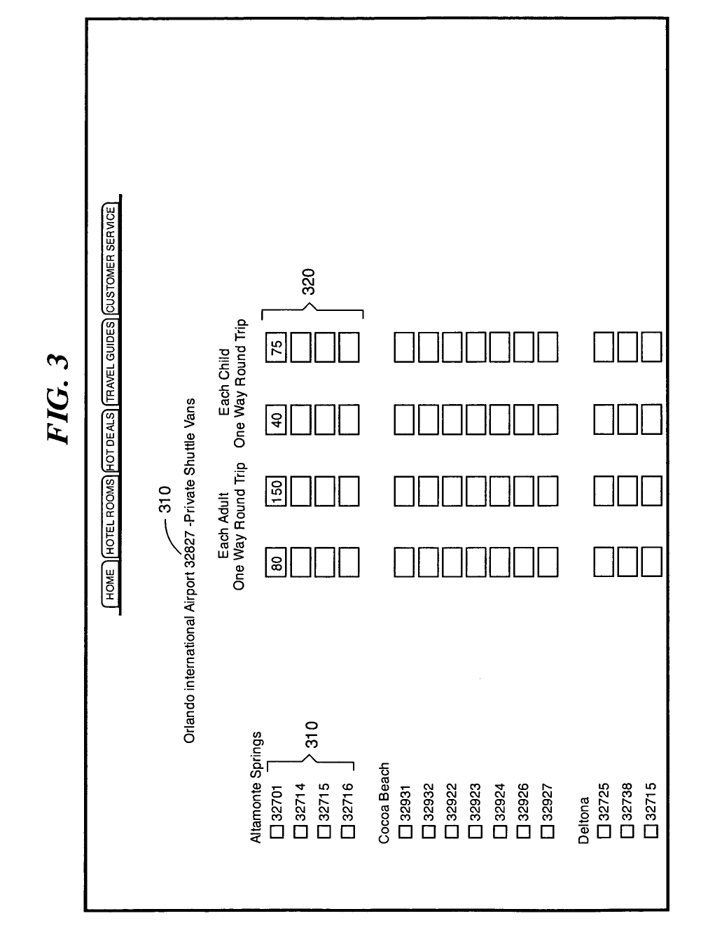

In a preferred embodiment, each vendor 20 sets a fare for travel within a single zone and a fare between each respective zone. This information is stored in database 22. In a further preferred embodiment, third party vendor 20 may input the information over the Internet at a web page as shown in FIG. 3. FIG. 3 is a screenshot for determining fares for a vendor relative to the Orlando International Airport. The location of the Orlando International Airport is identified by zip code 310, which in this instance is 32827 corresponding to the geographical zone. A chart is created for all of the other geographical areas by zip code. By way of example, Altamonte Springs has five distinct geographical areas identified by the respective zip codes 310. Utilizing a remote computer at third party vendor 20, third party vendor 20 may then input its fee schedule into fee schedule blocks 320. By way of example, this particular carrier may charge $80.00 for one way from the geographical zone 32827 to geographical zone 32701 and $150.00 for a round trip, while charging half price for each child. For those geographical zones for which no service is provided at any fee, the blocks will be left blank. The fee schedule mapped to the carrier ID and vehicle type is stored in database 22 by server 12 in accordance with step 208.

In a step 210, specific terms and conditions associated with each vehicle, van as opposed to sedan as opposed to stretch limousine or any other type of vehicle. Cancellation policies, luggage capacity, passenger capacity, airport pickup locations and the like can all be stored in terms and conditions in server 22 as terms and conditions associated with the carrier ID as stored in 204.

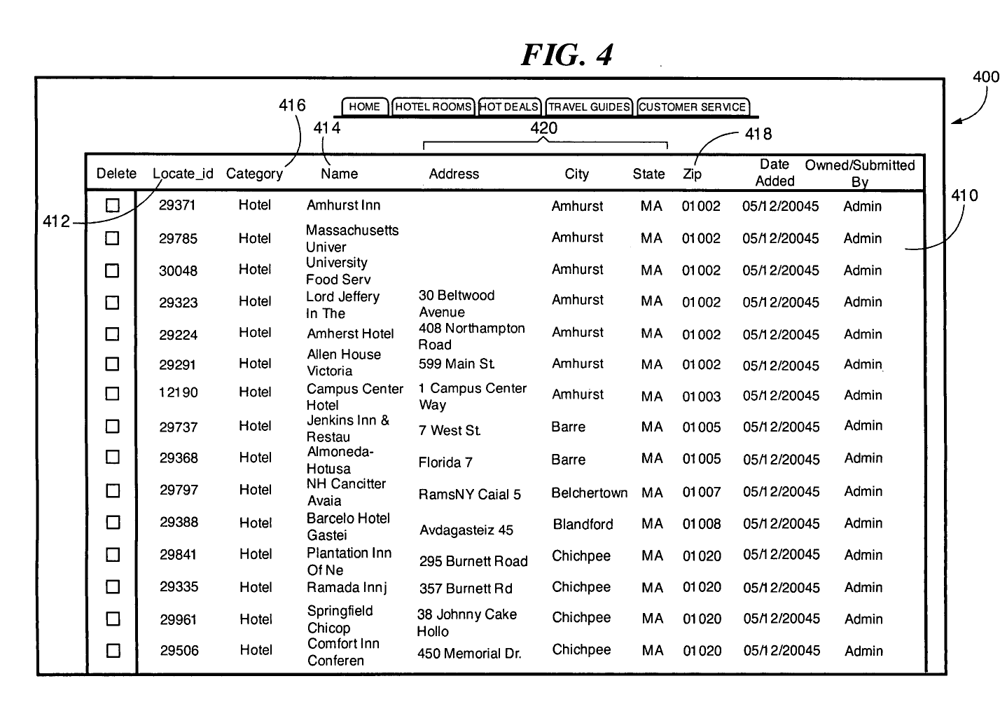

Reference is now made to FIG. 4 in which a screenshot of a location table for points of interest is provided. As discussed above in connection with step 202, certain points of interest such as airports, hotels and theme parks are conducive to repetitive needs for ground transportation by users 14. Accordingly, in step 202, a file such as Table 410, shown as a screenshot 400, may be utilized. By way of example, the first entry is a hotel, The Amherst Inn, which is identified by a location ID No.412 and name 414. The category of the destination such as hotel or stadium or theme park may also be stored as a category for 16. The zip code 418 is provided as the geographical zone indicator. It should be noted that the actual zip code may be used or an artificial zip code may be assigned converting the destination of interest into its own de facto geographical region such as with airports. In addition to the overall geographical location information 418, the specific address by street, city and state may also be stored as address data 420.

By storing the information in this manner, the origination location and destination location may be easily converted into a geographical zone when someone does not know the zip code or geographical zone, for example when arranging transportation from a destination airport.

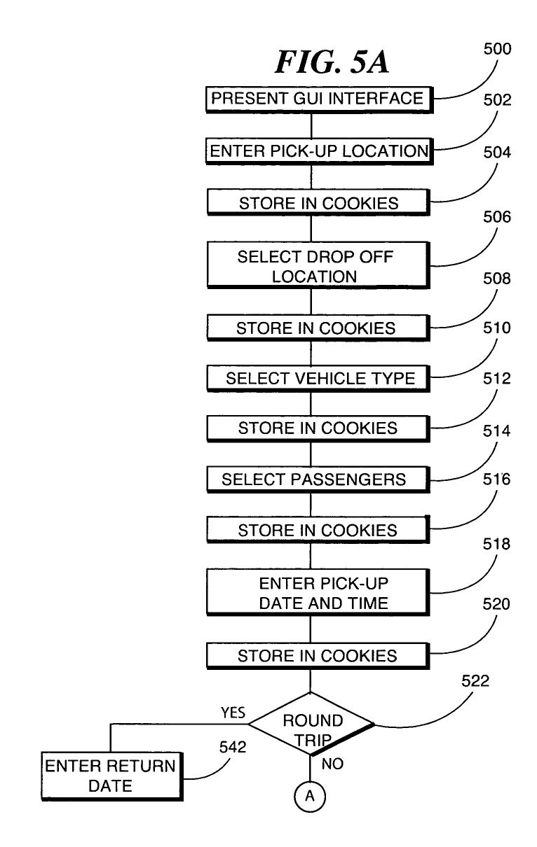

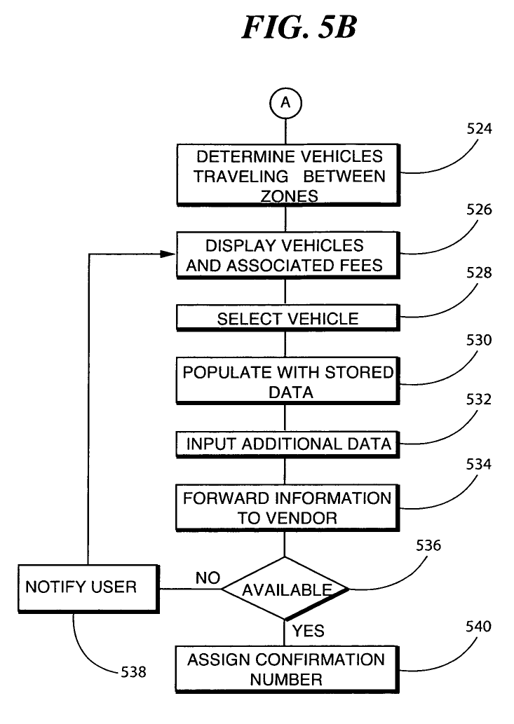

Reference is now made to FIG. 5 in which a method for reserving and booking ground transportation vehicles in accordance with the invention is provided.

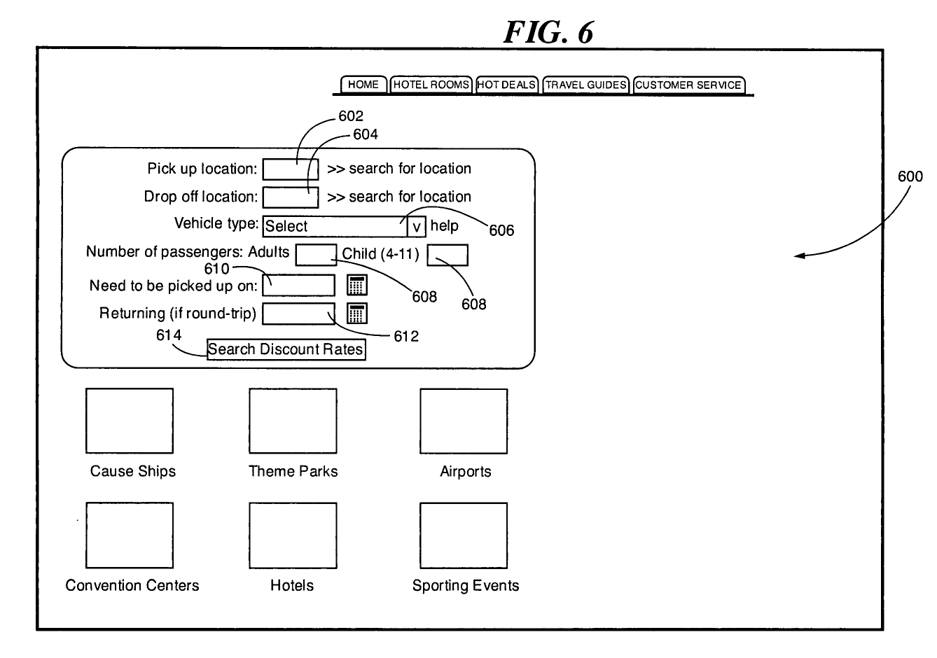

In a first step 500, a GUI interface is presented to user 14 at remote computer 16. As seen in FIG. 6, a screenshot of an exemplary GUI interface 600, which includes a pickup location field 602, a drop off location field 604, and a vehicle type field 606. Additionally, a field 608 is provided for the number of passengers broken down into adults and children. The pickup data is entered into field 610 and the return date, if any, entered into field 612.

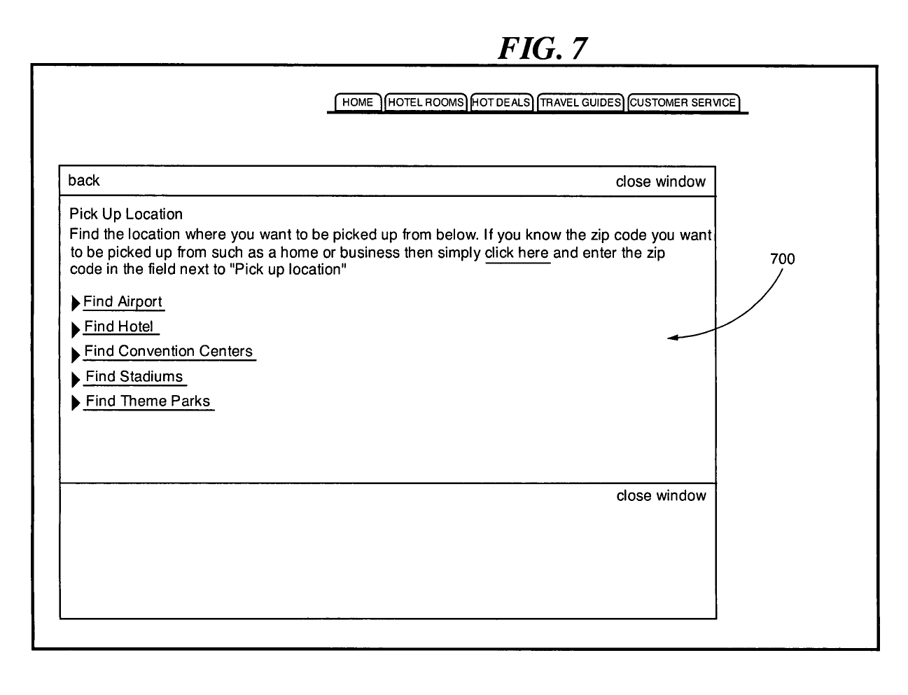

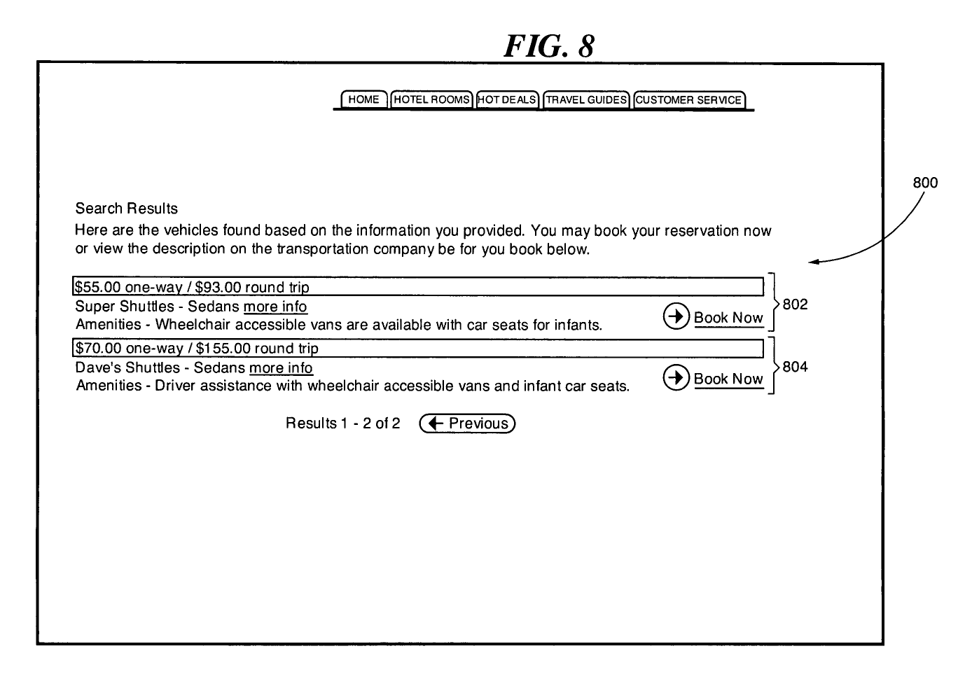

In step 502, the pickup location by geographical zone is input to field 602 by user 14 at remote location computer 16. Unless the trip is originating from the home or office of user 14, user 14 will not necessarily know the geographical zone. Either a hot link to another a web page, or as shown in FIG. 7, in a dropdown field 700, where generic pickup locations are provided. Once a category of pickup location such as “airport” is provided, user 14 will be connected through either a hot link to another web page or a dropdown table to airport listings and will be asked to choose a state. By selecting a state through a dropdown interface, all of the airports within a particular state will be provided. By selecting the desired airport in a state, server 12 populates field 602 with the zip code obtained from server 22 of the airport. In a step 504, the geographical zone and any other pertinent or desired information from table 410 is stored in cookies at remote computer 16 in a step 504.

Because airports are zip codes unto themselves in accordance with the invention, the pickup or drop off information entered in field 602, 604 can either be the airport symbol such as EWR for Newark or the zip code in order to avoid the need for the drop down tables. Entering this information causes server 12 to automatically formulate a screen with airline information request any of the pickup information field 904 or the drop off information field 906, dependent upon the nature of the trip.

Similarly, in a step 506, user 14 enters the geographical zone information for the drop off location in field 604 of screen 600. Again, if user 14 is unsure of the geographical zone, then hot links to dropdown fields boring down from generic destinations of interest, specific states having those destinations, and a specific location within the state as stored in database 22 can be used. Once selected, field 604 is populated with the geographic code information. The drop off geographical code is also stored in cookies at remote computer 16 in a step 508.

In a step 510, user 14 selects a vehicle type such as van, limousine, sedan, bus/motor coach, private shuttle, share ride van or town car, and enters the type in field 606. This information is preferably stored as cookies in a step 512. In a step 514, the number of adult and child passengers is entered in field 608. This information is also stored in cookies in a step 516. The date to be picked up is entered in field 610 in accordance with a step 518. Again, this information is stored as cookies in a step 520. In a step 522, it is determined whether the trip is to be a round trip. In other words, if returning transportation from the drop off location to pickup location will be required. If “yes,” then the returning date is entered in field 612 in a step 800.

If it is determined in step 522 that it is not a round trip, the location and address of the hotel or airport is also hidden in the cookies for later use. If it is determined to be a round trip, the return date is entered in step 540 and server 12 then automatically utilizes the drop off location as the pickup location for a return trip.

Upon completion of the fields on the GUI of page 600, user 14 will enter or select a submit icon or the like such as “search discount rates” icon 614. In response thereto, remote computer 16 forwards all of the information stored in the cookies to server 12. Server 12 determines which vehicles travel between the pickup location (origination zone) and the drop off location (destination zone) in a step 524. Server 12 identifies the origination zone from the information pulled from field 602 and the destination zone from the information pulled from field 604 and compares those zone codes to the zone codes stored in database 22. It searches for matches of stored vehicles which match vehicle type, origination zone code and destination zone code. It creates a list of vehicles and displays the vehicles with associated fares for the designated inter-zone travel at a web page in a step 526.

As shown in screen 800, in this example, which is by way of simplified example only, two matches were found which are displayed as respective entries 802 and 804. Each entry includes the name of the provider as well as the fares, car type (sedans in this example) and a hot link to more information such as the previously stored cancellation policies, luggage capacity, maximum passenger information and the like. In a step 528, user 14 indicates through remote computer 16 which vehicle is to be selected. The selection, along with the cookie information is sent to server 12 via Internet 18.

At the convenience of user 14, search results may be provided in alphabetical order by vendor, by lowest to increasing fare price or any other way in which the vendor stored data may be arranged.

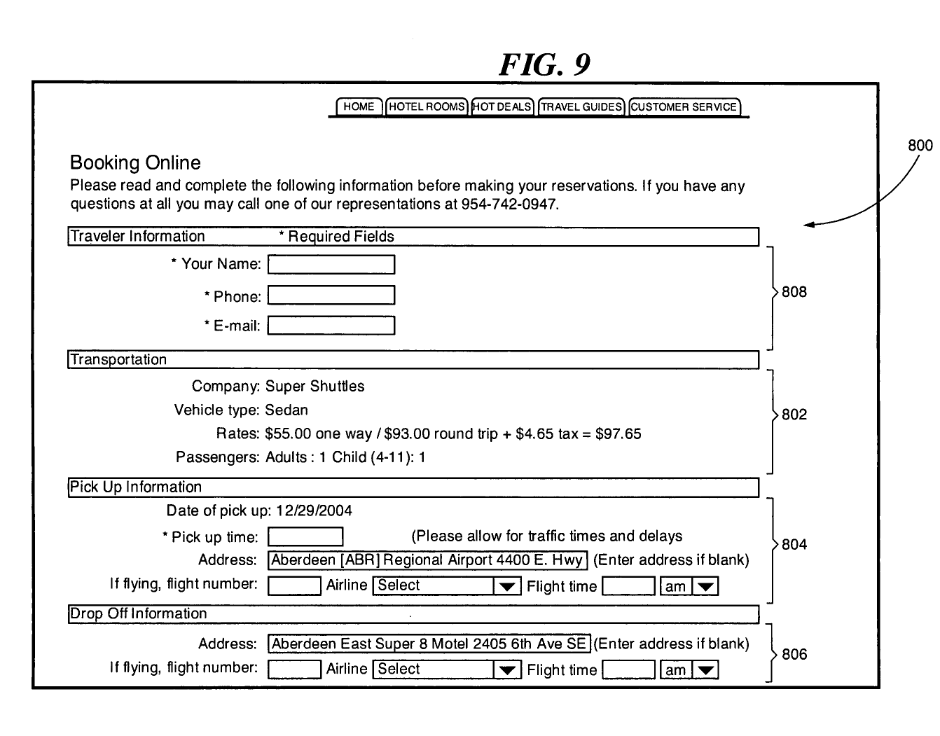

In a step 530, the stored information is utilized to populate a booking page 900 as seen in FIG. 9. By selecting a vehicle, the user is directed to a reservation page 900. All the information previously entered into the computer and stored as cookies along with the transportation company information from page 800, is pulled by server 12 and entered into the appropriate fields on the reservation form, thus expediting the process in a step 530. As can be seen, in the transportation fields 902 the fare information, vehicle type, vendor company, and passengers are all provided. Similarly, the pickup information, including the address of the regional airport, and the date of pickup is provided in pickup information fields 904. Although not completely shown, the drop off field 906 are similarly populated.

At this stage, what is required is for user 14 to populate the remaining information such as the contact information in traveler information field 908 and the exact pickup time information in field 904 and field 906 as well as flight number if any. This is done in a step 532. In this way, the anonymity of user 14 is maintained until they are actually committing to a vehicle.

If a round rip has been indicated, a pickup location similar in appearance to fields 904 or 906 (dependent upon on whether the return pickup location is an airport is provided) is displayed as the return pickup location. It should also be noted that part of the information which is prompted with respect to an airport are airplane information fields.

In a step 534, server 12 forwards the information to third party vendor 20. In the preferred embodiment, the information is transmitted over Internet 18 to a third party reservation software located at the computer of third party vendor 20. However, at this time, the server may cause a phone call or facsimile to be sent to the third party.

In a step 536, third party vendor 20 determines whether a vehicle is available on that date for use between the designated geographical zones. If not, third party vendor 20 notifies server 12 in a step 538 that the vehicle is not available and server 12 notifies user 14 at remote computer 16. The process is then repeated from step 526 in which the potentially available vehicles are displayed.

If it is determined in step 536 that the vehicles are available, third party vendor 20 books the reservation in accordance with its normal business practice and server 12 assigns a confirmation number in a step 540 which is transmitted both to third party vendor 20 and remote computer 16 for use by end user 14.

In a manner known in the art, payment is made across Internet 18 to server 12. The payment is held in escrow until third party vendor 20 confirms that the service has been delivered. In this way, cancellation may occur.

It should be noted, that the preferred embodiment utilizes cookies as a storage medium. However, it is contemplated that other memory mechanisms such as having server 12 store each individual entry or act on each entry in real time without need for storage may be provided.

By providing a server, which determines ground transportation availability and fares as a function of geographical zone traveled, instantaneous rates for any desired trip may be provided in real time. Furthermore, the availability of travel is no longer limited by “station-to-station” shortcomings and the limited universe of fixed locations. Also, by adding the actual address of the destination to the cookies of the remote computer allows for further flexibility of destinations rather than limiting a transportation company to only a few destinations.

Thus, while there have been shown, described and pointed out novel features of the present invention as applied to preferred embodiments thereof, it will be understood that various omissions and substitution and change in the form and detail are contemplated so that the disclosed invention may be made by those skilled in the art without departing from the spirit and scope of the invention. It is the intention therefore, to be limited only as indicated by the scope of the claims appended hereto. It is also to be understood that the following claims are intended to cover all of the generic and specific features of the invention herein described and all statements of the scope of the invention, which, as a matter of language, might be said to fall therebetween.

What is claimed as new and desired to be protected by Letters Patent of the United States is:

1. A method for reserving ground transportation vehicles comprising the steps of:
storing an inventory of ground transportation vehicles at a server, the inventory including information about each ground transportation vehicle including fees for travel in a respective ground transportation vehicle as a function of geographical zones to be traveled;
making a request from a remote computer in communication with said server for ground transportation vehicle, said request including an origination geographical zone and destination geographical zone; and
said server comparing the request to the inventory and determining those ground transportation vehicles that travel from the origination geographical zone to the destination geographical zone and forwarding those ground transportation vehicles and associated fees for traveling between the origination geographical zone and destination geographical zone to the remote computer for display.

2. The method of claim 1, further comprising the step of selecting the desired ground transportation vehicle and forwarding the selected ground transportation vehicle, fee, origination geographical zone and destination geographical zone to the server, and said server notifying a vendor corresponding to said selected vehicle of said selection and confirming availability of said selected ground transportation vehicle to said server.

3. The method of claim 1, wherein said origination geographical zone corresponds to a zip code.

4. The method of claim 1, wherein said destination geographical zone corresponds to a zip code.

5. The method of claim 1, wherein said origination geographical zone and destination geographical zone are stored as cookies at said remote computer, said server utilizing said information stored in said cookies in processing said request.

6. The method of claim 1, further comprising the step of determining an origination geographical zone by selecting a generic destination description;
said server determining a geographical location for said generic destination description, said server providing a geographical zone corresponding to said generic destination description in said selected geographical area.

7. The method of claim 1, further comprising the step of determining a destination geographical zone by selecting a generic origination description;
said server determining a geographical location for said generic origination description, said server providing a geographical zone corresponding to said generic origination description in said selected geographical area.

8. The method of claim 7, wherein said generic destination is selected from one of a website and dropdown page presented at said remote computer.

9. The method of claim 1, wherein said fees are stored at said server as a function of distance traveled, said server determining a distance between said origination geographical zone and destination geographical zone and determining said fee for travel between said origination geographical zone and destination geographical zone.

10. The method of claim 1, wherein specific fees for traveling between said origination geographical zone and destination geographical zone are stored as predetermined values.

11. The method of claim 1, wherein said information about each ground transportation vehicle includes the vehicle type, said request including a request for a vehicle type.

12. The method of claim 1, wherein said information about each ground transportation vehicle further includes at least one of maximum passenger capacity, terms and conditions of service, cancellation policy, and passenger capability.

13. A system for reserving ground transportation vehicles comprising
a remote computer;
a server communicating with said remote computer, said server storing an inventory of ground transportation vehicles, said inventory including information about each ground transportation vehicle, including fees for travel and a respective ground transportation vehicle as a function of geographical zones to be traveled, said remote computer making a request for ground transportation vehicles, said request including an origination geographical zone and a destination geographical zone; and
said server comparing the request to the inventory and determining those ground transportation vehicles that travel from the geographical zone to the destination geographical zone and forwarding said determined ground transportation vehicles and associated fees to said remote computer.

14. The system of claim 13, further comprising a vendor remote computer in communication with said server, said server communicating with said vendor remote computer and forwarding a selection from said remote computer corresponding to a vendor vehicle, said vendor remote computer confirming availability of said selected ground transportation vehicle to said server.

15. The system of claim 13, wherein said origination geographical zone corresponds to a zip code.

16. The system of claim 13, wherein said destination geographical zone corresponds to a zip code.
